(19) United States
(12) Patent Application Publication
(10) Pub. No.: US 2017/0169292 A1
(43) Pub. Date: Jun. 15, 2017

(54) SYSTEM AND METHOD FOR AUTOMATICALLY VERIFYING REQUESTS BASED ON ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/384,726

(22) Filed: Dec. 20, 2016

Related U.S. Application Data
(63) Continuation-in-part of application No. 15/361,934, filed on Nov. 28, 2016.
(60) Provisional application No. 62/295,159, filed on Feb. 15, 2016.
(60) Provisional application No. 62/260,553, filed on Nov. 29, 2015.
(60) Provisional application No. 62/261,355, filed on Dec. 1, 2015.

(51) Int. Cl. G06K 9/00; G06Q 30/04; G06F 17/30; G06K 9/62; G06K 9/18

(52) U.S. Cl. CPC G06K 9/00483; G06K 9/6202; G06K 9/00469; G06K 9/18; G06F 17/30011; G06F 17/30303; G06Q 30/04

(57) ABSTRACT

A system and method for automatically verifying requests based on electronic documents. The method includes analyzing a first electronic document to determine at least one transaction parameter, the first electronic document indicating the request, wherein the first electronic document includes at least partially unstructured data; creating a first template for the first electronic document, wherein the first template is a structured dataset including the determined at least one transaction parameter; retrieving, based on the first template, a second electronic document, wherein the second electronic document indicates evidence for verifying the request; and determining, based on the first template and the second electronic document, whether the request is verified.

### CROSS-REFERENCE TO RELATED APPLICATIONS

This application claims the benefit of U.S. Provisional Application No. 62/295,159 filed on Feb. 15, 2016, now pending. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to verifying files in data systems, and more particularly to verifying requests based on contents of electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Typically, to reclaim VATs paid during a transaction, evidence in the form of documentation indicating information related to the transaction (such as an invoice or receipt) must be submitted to an appropriate refund authority (e.g., a tax agency of the country refunding the VAT). If the information in the submitted documentation does not match the information submitted in the reclaim request, the request is denied and no reclaim is granted. To this end, employees of organizations often manually select and submit the required documentation for VAT reclaims in the form of electronic documents (e.g., an image file showing a scan of an invoice or receipt). This manual selection introduces potential for human error due to, for example, an employee providing incorrect information in the request and/or submitting unintended documentation (e.g., an invoice for another transaction). Existing solutions for automatically verifying transactions face challenges in utilizing electronic documents containing at least partially unstructured data.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for validating electronic documents. The method comprises: analyzing a first electronic document to determine at least one transaction parameter, the first electronic document indicating the request, wherein the first electronic document includes at least partially unstructured data; creating a first template for the first electronic document, wherein the first template is a structured dataset including the determined at least one transaction parameter; retrieving, based on the first template, a second electronic document, wherein the second electronic document indicates evidence for verifying the request; and determining, based on the first template and the second electronic document, whether the request is verified.

Certain embodiments disclosed herein also include a non-transitory computer readable medium having stored thereon instructions for causing a processing circuitry to perform a process, the process comprising: analyzing a first electronic document to determine at least one transaction parameter, the first electronic document indicating the request, wherein the first electronic document includes at least partially unstructured data; creating a first template for the first electronic document, wherein the first template is a structured dataset including the determined at least one transaction parameter; retrieving, based on the first template, a second electronic document, wherein the second electronic document indicates evidence for verifying the request; and determining, based on the first template and the second electronic document, whether the request is verified.

Certain embodiments disclosed herein also include a system for validating electronic documents. The system comprises: a processing circuitry; and a memory, the memory containing instructions that, when executed by the processing circuitry, configured the system to: analyze a first electronic document to determine at least one transaction parameter, the first electronic document indicating the request, wherein the first electronic document includes at least partially unstructured data; create a first template for the first electronic document, wherein the first template is a structured dataset including the determined at least one transaction parameter; retrieve, based on the first template, a second electronic document, wherein the second electronic document indicates evidence for verifying the request; and determine, based on the first template and the second electronic document, whether the request is verified.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for automatically verifying requests based on electronic documents according to an embodiment.

FIG. 4 is a flowchart illustrating a method for creating a dataset based on at least one electronic document according to an embodiment.

FIG. 5 is a flowchart illustrating a method for verifying a request based on a first electronic document and a second electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for automatically verifying requests based on electronic documents. In an embodiment, a dataset is created based on a first electronic document indicating information related to a request. The request may be for a reclaim of value-added taxes (VATs) paid during a transaction. A template of transaction attributes is created based on the first electronic document dataset. Optionally, it may be determined whether the transaction is eligible for the request.

Based on the template created for the first electronic document, a second electronic document indicating evidence supporting the request is retrieved. Optionally, a first data source may be queried to validate the first electronic document and a second data source may be queried to validate the second electronic document. Based on the first electronic document and the second electronic document, it is determined whether the request is verified. The verification may include creating a template for the second electronic document. When the request is verified, the first electronic document and the second electronic document may be stored in a database for later use.

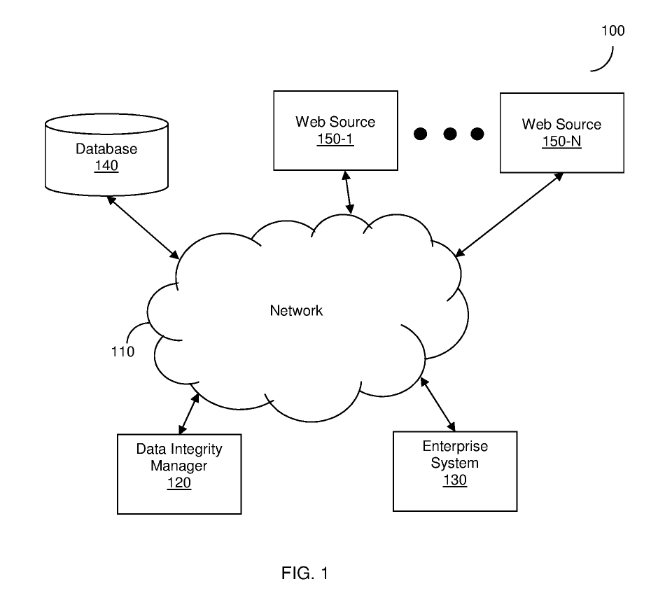

FIG. 1 shows an example network diagram 100 utilized to describe the various disclosed embodiments. In the example network diagram 100, a request verifier 120, an enterprise system 130, a database 140, and a plurality of web sources 150-1 through 150-N (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise system 130 may further store data related to requests (e.g., requests for VAT reclaims) to be submitted by the enterprise (e.g., an image file showing a VAT reclaim request form submitted by an employee of the enterprise). The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, etc.). Each electronic document may show, e.g., an invoice, a tax receipt, a purchase number record, a VAT reclaim request, and the like. Data included in each electronic document may be structured, semi-structured, unstructured, or a combination thereof. The structured or semi-structured data may be in a format that is not recognized by the request verifier 120 and, therefore, may be treated as unstructured data.

The database 140 may store data verified by the request verifier 120 to be utilized for submitting requests. Such data may include, e.g., sets of electronic documents, each set including at least a first electronic document indicating the request and a second electronic document utilized as evidence for the request of the first electronic document.

The web sources 150 store at least electronic documents that may be utilized as evidence for granting requests. The web sources 150 may include, but are not limited to, servers or devices of merchants, tax authority servers, accounting servers, a database associated with an enterprise, and the like. As a non-limiting example, the web source 150-1 may be a merchant server storing image files showing invoices for transactions made by a merchant associated with the merchant server.

In an embodiment, the request verifier 120 is configured to create a template based on transaction parameters identified using machine vision of a first electronic document indicating information related to a VAT reclaim request with respect to a transaction. In a further embodiment, the request verifier 120 may be configured to retrieve the first electronic document from, e.g., the enterprise system 130. Based on the created template, the request verifier 120 is configured to retrieve a second electronic document indicating information evidencing the transaction.

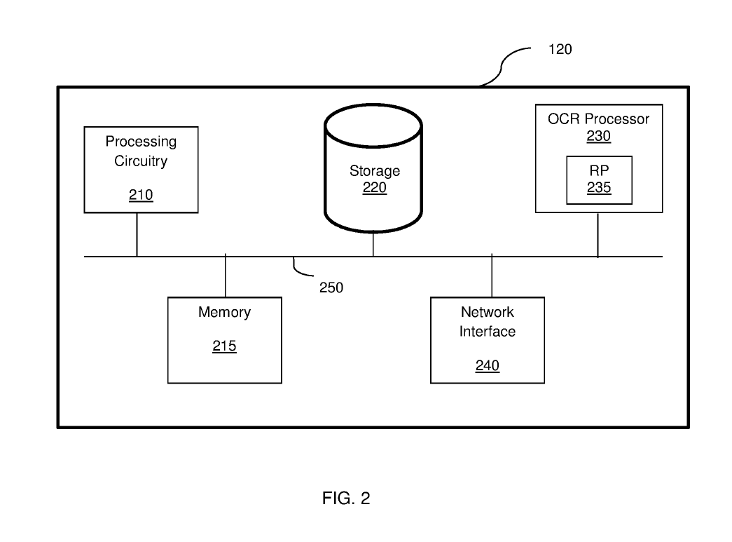

In an embodiment, the request verified 120 is configured to create datasets based on electronic documents including data at least partially lacking a known structure (e.g., unstructured data, semi-structured data, or structured data having an unknown structure). To this end, the request verifier 120 may be further configured to utilize optical character recognition (OCR) or other image processing to determine data in the electronic document. The request verifier may therefore include or be communicatively connected to a recognition processor (e.g., the recognition processor 235, FIG. 2).

In an embodiment, the request verifier 120 is configured to analyze the created datasets to identify transaction parameters related to transactions indicated in the electronic documents. In an embodiment, the data integrity manager 120 is configured to create templates based on the created datasets. Each template is a structured dataset including the identified transaction parameters for a transaction.

In an embodiment, the request verifier 120 is configured to create a first template based on the first electronic document. In a further embodiment, the request verifier 120 may be configured to determine whether the transaction indicated in the first electronic document is eligible for a VAT reclaim. In yet a further embodiment, the request verifier 120 may be further configured to compare data of the first template to at least one VAT reclaim requirement retrieved from, e.g., one of the web sources 150, based on the first template. The VAT reclaim requirements may be in the form of, e.g., rules. For example, based on a first electronic document showing a scan of a VAT reclaim request form for a purchase made in Germany, VAT reclaim requirements are retrieved from a German tax authority server. The retrieved VAT reclaim requirements include a requirement that the entity seeking the reclaim is not a German entity such that, if a “buyer country” field in the first template indicates that the buyer is a German entity, the transaction is determined to be ineligible for VAT reclaim.

In an embodiment, based on the first template, the request verifier 120 is configured to retrieve the second electronic document for use as evidence needed to grant the request. In a further embodiment, retrieving the second electronic document may include searching in at least one of the web sources 150 based on data in the first template. As a non-limiting example, if data in the first template indicates a request for VAT reclaim based on a purchase made in Russia, the second electronic document may be retrieved from a web source 150-2 associated with a Russian tax authority. As another non-limiting example, if data in the first template indicates a request for VAT reclaim based on a purchase of goods from ABC Company, the second electronic document may be retrieved from a web source 150-3 associated with ABC Company.

In an embodiment, the request verifier 120 is configured to determine whether the request is verified based on the first electronic document and the second electronic document. In a further embodiment, determining whether the request is verified may further include generating a second template for the second electronic document based on machine imaging analysis of the second electronic document. In yet a further embodiment, determining whether the request is verified includes comparing data in the first template with data in the second template. As a non-limiting example, values in respective “VAT” fields of the first template and the second template may be compared and, if the compared values do not match, the request is not verified. The matching may be based on, e.g., a predetermined threshold.

In another embodiment, when it is determined that the request is not verified, a notification indicating the failed verification may be generated and sent to, e.g., the enterprise system 130.

In yet another embodiment, the request verifier 120 may be further configured to validate each of the first electronic document and the second electronic document based on the first and second templates, respectively. The validation may include, but is not limited to, determining whether each of the first electronic document and the second electronic document is complete and accurate.

Each electronic document may be determined to be complete if, for example, one or more predetermined reporting requirements is met (e.g., for a VAT, reporting requirements may include requiring each of type of goods or services purchased, country of seller, country of buyer, and amount of VAT paid).

Each electronic document may be determined to be accurate based on data stored in at least one external source. The at least one electronic source may include, but is not limited to, the enterprise system 130, one or more of the web sources 150, the database 140, or a combination thereof. Examples of determining accuracy follow.

As an example, the enterprise system 130 may be queried for data related to the enterprise, and the data related to the enterprise may be compared to at least a portion of data of the templates (e.g., data of fields related to enterprise information) to determine whether the at least a portion of the data is accurate.

As another example, the web source 150-7 may be queried for metadata related to the second electronic document, and the queried metadata may be compared to data of the second template.

As yet another example, the database 140 may be queried for data of previously verified requests, and the previously verified request data may be compared to at least a portion of data of the first template, the second template, or both, to determine whether the at least a portion of data matches the previously verified request data and, therefore, is accurate. This is because previously verified transaction data may be considered to likely be accurate.

In an embodiment, when it is determined that the request is not verified, a cause of the failure to verify may be determined. Potential causes of failure to verify may include circumstances or assumptions related to the cause of a difference between, e.g., the first template and the second template. The potential causes may be determined based on one or more causation rules. In an embodiment, the causation rules may include potential causes associated with particular values for differences in price or multiples thereof. In a further embodiment, the causation rules may further be based on whether the difference is positive (e.g., a price in an invoice is higher than a price in a request) or negative, (e.g., a price in an invoice is lower than a price in a request).

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the request verifier 120 according to an embodiment. The request verifier 120 includes a processing circuitry 410 coupled to a memory 215, a storage 220, and a network interface 240. In an embodiment, the data integrity manager 120 may include an optical character recognition (OCR) processor 230. In another embodiment, the components of the request verifier 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to perform automatic verification of requests based on electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a request.

The network interface 240 allows the data integrity manager 120 to communicate with the enterprise system 130, the database 140, the web sources 150, or a combination of, for the purpose of, for example, collecting metadata, retrieving data, storing data, and the like.

It should be understood that the embodiments described herein are not limited to the specific architecture illustrated in FIG. 2, and other architectures may be equally used without departing from the scope of the disclosed embodiments.

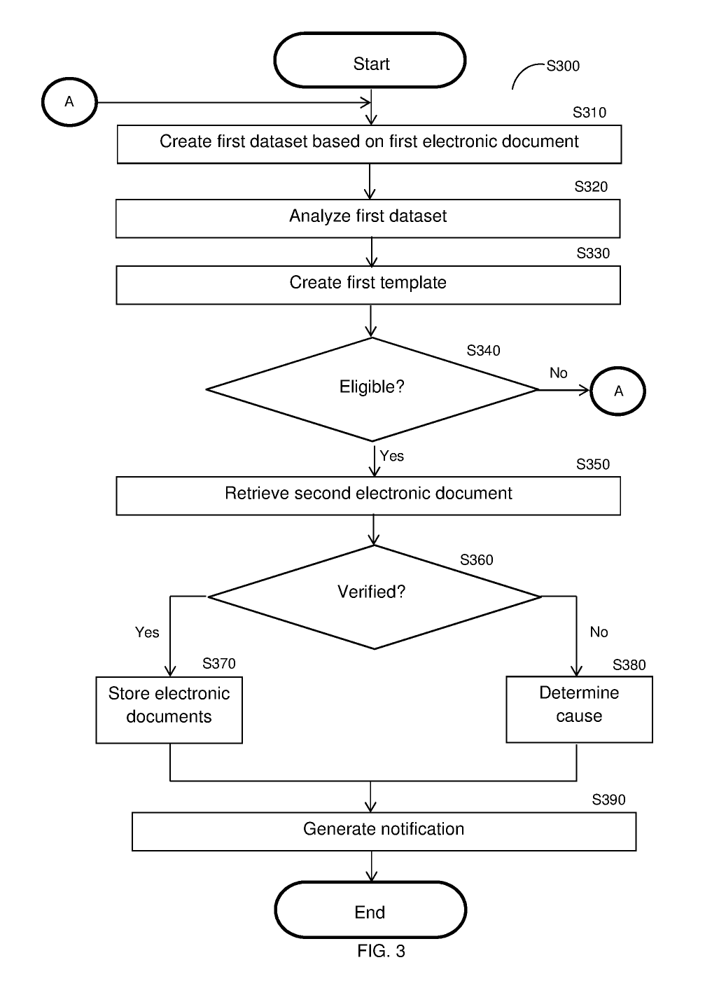

FIG. 3 is an example flowchart 300 illustrating a method for automatically verifying requests based on electronic documents according to an embodiment. In an embodiment, the method may be performed by a request verifier (e.g., the request verifier 120).

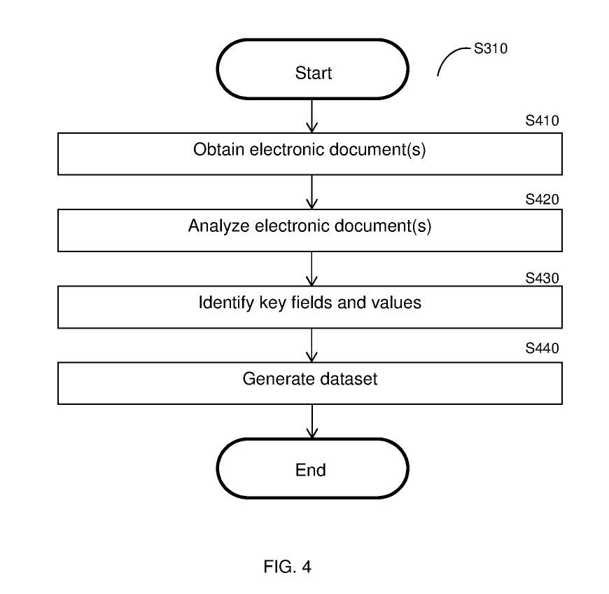

At S310, a first dataset is created based on a first electronic document including information related to a transaction. The first electronic document may include, but is not limited to, unstructured data, semi-structured data, structured data with structure that is unanticipated or unannounced, or a combination thereof. In an embodiment, S310 may further include analyzing the first electronic document using optical character recognition (OCR) to determine data in the electronic document, identifying key fields in the data, identifying values in the data, or a combination thereof. Creating datasets based on electronic documents is described further herein below with respect to FIG. 4.

At S320, the first dataset is analyzed. In an embodiment, analyzing the first dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the first dataset may also include identifying the transaction based on the first dataset.

At S330, a first template is created based on the first dataset. The first template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At optional S340, it is determined, based on the first template, whether a request indicated in the first electronic document is eligible for verification and, if so, execution continues with S350; otherwise, execution terminates. In an embodiment, S330 may include determining whether the created first template meets at least one predetermined constraint. A request may be eligible for verification if, e.g., the first template meets the at least one predetermined constraint. The at least one predetermined constraint may include, but is not limited to, requirements on types of information needed for verification, accuracy requirements, or a combination thereof. The information needed for verification may further include information required for successfully submitting VAT reclaims requests. For example, if an electronic document does not include a country for the merchant enterprise in a transaction or a price of the transaction, successful VAT reclaiming may not be possible. Determining whether the request is eligible for verification may reduce use of computing resources by only verifying using templates meeting minimal requirements.

In another embodiment, S340 may further include determining at least one constraint based on the first template. In a further embodiment, determining the at least one constraint may include searching in at least one database based on the first template (e.g., using a location of the merchant enterprise indicated in the first template). In yet a further embodiment, S330 may also include analyzing at least one reporting requirement electronic document (e.g., a VAT reclaim form) to determine the at least one constraint. The analysis may further include performing OCR or other image processing on each reporting requirements electronic document.

In another embodiment, when it is determined that the request is not eligible for verification, additional data, replacement data, or both may be retrieved from at least one data source and included in the first template. In a further embodiment, upon retrieving the additional or replacement data, execution continues with S350. In another embodiment, upon retrieving the additional or replacement data, it is determined whether the request is eligible based on the updated first template and, if so, execution continues with S350; otherwise, execution terminates.

At S350, a second electronic document is retrieved based on the first template. In an embodiment, S350 includes searching, based on data in the first template, in at least one web source. As a non-limiting example, a transaction identification number “123456789” indicated in a “Transaction ID” field of the first template may be utilized as a search query to find the second electronic document based on, e.g., metadata of the second electronic document including the transaction identification number “123456789.” In a further embodiment, S350 further includes selecting the at least one web source based on the first template.

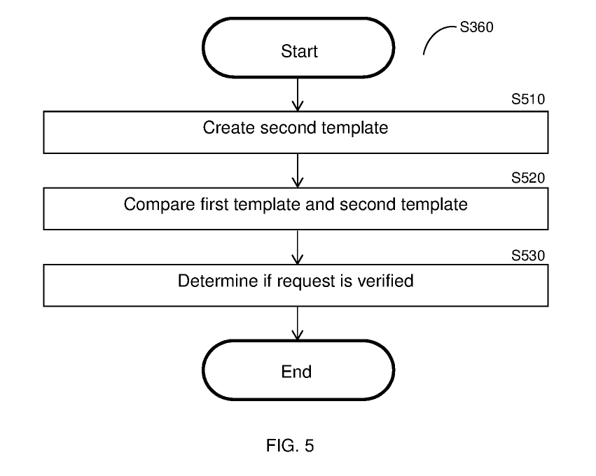

At S360, it is determined, based on the first template and the second electronic document, whether the request indicated in the first electronic document is verified and, if so, execution continues with S370; otherwise, execution continues with S380. In an embodiment, S360 includes generating a second template for the second electronic document (e.g., using the method described further herein below with respect to FIG. 4). In a further embodiment, S360 further includes comparing data in the first template with data in the second template. In another embodiment, S360 may include validating at least one of the first electronic document and the second electronic document. Determining whether a request is verified based on a first electronic document and a second electronic document is described further herein below with respect to FIG. 5.

At S370, when it is determined that the request is verified, the first electronic document and the second electronic document are stored in, e.g., a database including first electronic documents indicating VAT reclaim requests and corresponding second electronic documents indicating evidence supporting the respective requests. Thus, the first electronic document and the second electronic document may be submitted together for a VAT reclaim.

At S380, when it is determined that the request is not verified, at least one cause is determined. In an embodiment, S380 includes analyzing each mismatched set of parameters to analyze differences therein and analyzing the identified differences. The causes may include, but are not limited to, missing evidence as compared to the actual report, errors in reports, duplicated reports, etc. In an embodiment, S380 may further include providing indications of a source that actually provided the mismatched data, the reasons for the mismatches, or both.

As a non-limiting example, an indication that a particular employee or department that submitted the actual report may be provided. As another non-limiting example, an indication that the mismatch occurred due to smudging of a VAT reclaim form may be provided. As another non-limiting example, when a VAT of $580 from a purchase of a smart phone is reclaimed and, based on an analysis, it is determined that an additional purchase of a SIM card was made with the smart phone for a total VAT amount of $600, the cause of the mismatch may be determined to be a failure to reclaim all potentially reclaimed VATs.

At optional S390, a notification may be generated. The notification may indicate whether the request is verified. In another embodiment, when the request is not verified, the notification may include the determined at least one cause.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

FIG. 5 is an example flowchart S360 illustrating a method for determining whether a request is verified based on a first electronic document and a second electronic document according to an embodiment. In an embodiment, the method is based further on a first template created for the first electronic document (e.g., a template created as described further herein above with respect to FIG. 4). In another embodiment, the first electronic document may indicate a request for a VAT reclaim, and the second electronic document may indicate information used as evidence to support the VAT reclaim request (i.e., the second document may be an invoice, a receipt, etc.).

At S510, a second template is created based on the second electronic document. In an embodiment, S510 includes performing machine imaging on the second electronic document. The second template may be created as described further herein above with respect to FIG. 4.

At S520, the first template and the second template are compared. In an embodiment, S520 includes comparing each portion of the first template to a corresponding portion of the second template. In a further embodiment, S520 may further include identifying the corresponding portions based on a structure of each template. As a non-limiting example, data in fields occupying the same relative location in each template may be corresponding.

At S530, based on the comparison, it is determined if the request is verified. In an embodiment, S530 includes determining whether each set of corresponding portions matches above a predetermined threshold based on one or more matching rules. As a non-limiting example, the values “ [symbol] 100” and “100.00” in the field “Price (Euros)” of the first template and the second template, respectively, may be determined to match.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automatically verifying a request based on electronic documents, comprising:
analyzing a first electronic document to determine at least one transaction parameter, the first electronic document indicating the request, wherein the first electronic document includes at least partially unstructured data;
creating a first template for the first electronic document, wherein the first template is a structured dataset including the determined at least one transaction parameter;
retrieving, based on the first template, a second electronic document, wherein the second electronic document indicates evidence for verifying the request; and
determining, based on the first template and the second electronic document, whether the request is verified.

2. The method of claim 1, wherein determining the at least one transaction parameter further comprises:
identifying, in the first electronic document, at least one key field and at least one value;
creating, based on the first electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the first electronic document to determine data in the first electronic document; and
extracting, based on a predetermined list of key fields, at least a portion of the determined data, wherein the at least a portion of the determined data matches at least one key field of the predetermined list of key fields.

4. The method of claim 3, wherein analyzing the first electronic document further comprises:
performing optical character recognition on the first electronic document.

5. The method of claim 4, further comprising:
performing a cleaning process on the extracted at least a portion of the determined data.

6. The method of claim 4, further comprising:
checking if each piece of data of the extracted at least a portion of the determined data is completed; and
for each piece of data that is not completed, performing at least one of: querying at least one external source, and correlating the determine data with data of at least one previously analyzed electronic document.

7. The method of claim 1, wherein determining whether the request is verified further comprises:
creating, based on the second electronic document, a second template, wherein the second template is a structured dataset including data of the second electronic document;
comparing the first template and the second template, wherein determining whether the request is verified is based on the comparison.

8. The method of claim 7, wherein comparing the first template and the second template further comprises:
comparing each portion of the first template to a corresponding portion of the second template; and
determining whether each portion of the first template matches the corresponding portion of the second template.

9. The method of claim 1, wherein the first electronic document is an image showing a value-added tax reclaim request, wherein the second electronic document is an image showing at least one of: an invoice, a receipt, and a purchase number record.

10. A non-transitory computer readable medium having stored thereon instructions for causing a processing circuitry to perform a process, the process comprising:
analyzing a first electronic document to determine at least one transaction parameter, the first electronic document indicating the request, wherein the first electronic document includes at least partially unstructured data;
creating a first template for the first electronic document, wherein the first template is a structured dataset including the determined at least one transaction parameter;
retrieving, based on the first template, a second electronic document, wherein the second electronic document indicates evidence for verifying the request; and
determining, based on the first template and the second electronic document, whether the request is verified.

11. A system for validating a transaction represented by an electronic document, comprising:
a processing circuitry; and
a memory, the memory containing instructions that, when executed by the processing circuitry, configure the system to:
analyze a first electronic document to determine at least one transaction parameter, the first electronic document indicating the request, wherein the first electronic document includes at least partially unstructured data;
create a first template for the first electronic document, wherein the first template is a structured dataset including the determined at least one transaction parameter;
retrieve, based on the first template, a second electronic document, wherein the second electronic document indicates evidence for verifying the request; and
determine, based on the first template and the second electronic document, whether the request is verified.

12. The system of claim 11, wherein the system is further configured to:
identify, in the first electronic document, at least one key field and at least one value;
create, based on the first electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the first electronic document to determine data in the first electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the first electronic document.

15. The system of claim 14, wherein the system is further configured to:
perform a cleaning process on the extracted at least a portion of the determined data.

16. The system of claim 14, wherein the system is further configured to:
check if each piece of data of the extracted at least a portion of the determined data is completed; and
for each piece of data that is not completed, perform at least one of: querying at least one external source, and correlating the determine data with data of at least one previously analyzed electronic document.

17. The system of claim 11, wherein the system is further configured to:
create based on the second electronic document, a second template, wherein the second template is a structured dataset including data of the second electronic document;
compare the first template and the second template, wherein determining whether the request is verified is based on the comparison.

18. The system of claim 17, wherein the system is further configured to:
compare each portion of the first template to a corresponding portion of the second template; and
determine whether each portion of the first template matches the corresponding portion of the second template.

19. The system of claim 11, wherein the first electronic document is an image showing a value-added tax reclaim request, wherein the second electronic document is an image showing at least one of: an invoice, a receipt, and a purchase number record.
